(19) United States
(12) Patent Application Publication
(10) Pub. No.: US 2011/0032984 A1
(43) Pub. Date: Feb. 10, 2011

(54) Methods circuits and systems for transmission of video

(76) Inventors: Guy Dorman, Holon (IL); Zvi Reznic, Tel Aviv (IL); Shmuel Lifsches, Tel-Aviv (IL); Daniel Stopler, Holon (IL)

Correspondence Address: EITAN MEHULAL LAW GROUP, 10 Abba Eban Blvd. PO Box 2081, Herzlia, 46120, IL

(21) Appl. No.: 12/923,327

(22) Filed: Sep. 15, 2010

Related U.S. Application Data
(63) Continuation-in-part of application No. 12/458,568, filed on Jul. 16, 2009.
(60) Provisional application No. 61/081,408, filed on Jul. 17, 2008.

(51) Int. Cl. H04N 7/30; H04N 7/26

(52) U.S. Cl. 375/240.2; 375/240.24; 375/E07.026; 375/E07.226

(57) ABSTRACT

Disclosed are methods, circuits and systems for transmission of a video block. A video stream may be composed of sequential video frames, and each video frame may be composed of one or more video blocks including a set of pixels. Prior to transmission of the data associated with a video block, a signature of the video block may be generated, for example using a spatial to frequency transform such as a two dimensional discrete cosine transform. Signatures of corresponding video blocks across consecutive video frames may be compared in order to determine whether a given video block of a current video frame is static or dynamic relative to prior video corresponding video blocks. Transmission parameters of the given block may depend on whether the block is designated as static or dynamic.

### RELATED APPLICATIONS

The present application is a continuation-in-part of U.S. patent application Ser. No. 12/458,568 filed on Jul. 16, 2009, which claims benefit of U.S. Provisional Application 61/081,408 file on Jul. 17, 2008, and hereby incorporated by reference in its entirety.

### FIELD OF THE INVENTION

The present invention relates generally to the field of video transmission. More specifically, the present invention relates to the detection of changes in the data of a transmitted video signal.

### BACKGROUND

Wireless communication has rapidly evolved over the past decades. Even today, when high performance and high bandwidth wireless communication equipment is made available there is demand for even higher performance at higher data rates for more demanding applications. Video bearing signals may be generated by various video sources, for example, a computer, a game console, a Video Cassette Recorder (VCR), a Digital-Versatile-Disc (DVD), or any other suitable video source. In many houses, for example, video content is received through cable or satellite links at a Set-Top Box (STB) located at a fixed point.

In many cases, it may be desired to place a display, screen or projector at a location at a distance of at least a few meters from the video source. This trend is becoming more common as flat-screen displays, e.g., plasma or Liquid Crystal Display (LCD) televisions are hung on walls. Connection of such a display or projector to the video source through cables is generally undesired for aesthetic reasons and/or installation convenience. Thus, wireless transmission of the video signals from the video source to the screen may be preferable.

Often, flat screen displays are designed for viewing High-Definition-Television (HDTV) signals that may demand high data rates for transmission since the data is often uncompressed. Existing video data compression/decompression techniques may not be adequate for wireless transmission of HDTV signals at acceptable quality levels due to latency and may not be compatible with all video sources.

### SUMMARY OF THE INVENTION

The present invention includes methods, circuits and systems for static/dynamic frame detection. According to some embodiments of the present invention, a video frame may be divided to one or more video blocks. According to some embodiments of the present invention, a video block may be constructed from at least one video component block. According to some embodiments of the present invention, a discrete cosine transform (DCT) may be applied to each of the video component blocks to create one or more video DCT coefficient blocks. According to some embodiments of the present invention, one or more hash functions may be applied to one or more coefficients of the video DCT coefficient block. According to some embodiments of the present invention, the output from the hash functions may be concatenated to create a video block signature. According to some embodiments of the present invention, a block's signature may be compared to a previous block's signature (optionally: using a correction table) to determine whether the difference between the two video blocks is within a predefined threshold. According to some embodiments of the present invention, a counter may count the number of times a block matches its corresponding previous block(s) consecutively. According to some embodiments of the present invention, a block may be defined as static when the counter reaches a predefined number (e.g. 1 to 10). According to some embodiments of the present invention, a video block may be defined as static only if a certain percentage of its predefined neighbors are static.

Disclosed are methods, circuits and systems for transmission of a video block. A video stream may be composed of sequential video frames, and each video frame may be composed of one or more video blocks including a set of pixels. Prior to transmission of the data associated with a video block, a signature of the video block may be generated, for example using a spatial to frequency transform such as a two dimensional discrete cosine transform. Signatures of corresponding video blocks across consecutive video frames may be compared in order to determine whether a given video block of a current video frame is static or dynamic relative to prior video corresponding video blocks. Transmission parameters of the given block may depend on whether the block is designated as static or dynamic.

According to some embodiments of the present invention, there may be provided a method for processing video data including determining a deviation between a given video block in a current video frame relative to a corresponding video block in a previous video frame by comparing a signature of the given block with a signature of the corresponding previous video block. The method may include generating a signature for the given video block by performing a discrete cosine transform (DCT) on one or more of component blocks of the given video block to produce one or more DCT blocks of coefficients. A video block signature may be generated by calculating a hash function of at least one of the coefficients of at least one of the DCT blocks. A video block signature may be generated by calculating a hash function of at least a DC coefficient of at least one of the component DCT coefficient block. A video block signature may be generated by calculating a hash function of at least a DC coefficient of a Y DCT coefficient block. A video block signature may be generated by calculating a hash function of a DC coefficient and at least one AC coefficient, of at least one of the component DCT coefficient blocks. A video block signature may be generated by calculating a hash function of a DC coefficient and at least one AC coefficient of a Y DCT coefficient block.

According to some embodiments of the present invention, there may be provided a video transmitting device including a video block signature generator adapted to generate a signature for a given block in a current video frame, and a comparator adapted to determine a deviation between the given video block of the current video frame relative to a corresponding video block in a previous video frame by comparing signatures of the two video blocks. The generator may be adapted to generate a signature for the given video block by performing a discrete cosine transform (DCT) on one or more of component blocks of the given video block to produce one or more DCT blocks of coefficients.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows the breakdown and transitions of a video frame according to some embodiments of the present invention;

FIG. 2 shows an example of a discrete cosine transform (DCT) of a video block;

FIG. 3 shows an exemplary correction table according to some embodiments of the present invention;

FIG. 4 is an exemplary calculation of a block signature according to some embodiments of the present invention;

FIG. 5 shows 6 exemplary patterns for determining a static block based on its static neighboring blocks;

FIG. 6 shows an example of a block matrix for determining static/dynamic blocks based on the block's neighbors;

FIG. 7 is an exemplary flowchart of some embodiments according to the present invention showing the steps of generating a block signature and determining whether a block is static or dynamic;

FIG. 8 is an exemplary block diagram of a processing/logic circuit according to some embodiments of the present invention; and

FIG. 9 is an exemplary block diagram of another processing/logic circuit according to some other embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

In video transmission, whether wired or wireless, there may be a need to save power and/or bandwidth. Therefore, there may be a need to detect if a frame or portions of a frame are static or dynamic.

According to some embodiments of the present invention, there may be a video stream which may be constructed from a sequence of video frames. According to some embodiments of the present invention, a video frame may be constructed from pixels in the horizontal and vertical direction, for example 1920×1080 pixels. According to some embodiments of the present invention, a video frame may be divided into one or more video blocks. For example, a 1920×1080 pixels video frame may be divided into four 960×540 pixels video blocks, or into 32,400 8×8 pixels video blocks. According to some embodiments of the present invention, each pixel may be represented by one or more components representing the pixel's color components and/or luma and chroma components.

According to some embodiments of the present invention, each video block may be constructed from one or more video component blocks. For example, a RGB encoded video frame may be constructed from R video blocks, G video blocks, and B video blocks.

According to some embodiments of the present invention, a discrete cosine transform (DCT) may be applied to each video component block of the video block, generating a component DCT coefficient block. According to some embodiments of the present invention, the collective component DCT coefficient blocks of a certain video block may be referred to as DCT block. For example, in the YCbCr encoding scheme, there may be a Y DCT coefficient block, a Cb DCT coefficient block, and a Cr DCT coefficient block and collectively DCT block.

According to some embodiments of the present invention, a video block may be assigned a video signature. The video signature may represent the information in the video block in a way that two video blocks that have identical video content may have the same video signature.

According to some embodiments of the present invention, there may be a hash function such as Cyclic Redundancy Check (CRC), checksum, SHA, modulus, or any other hash function now known or that may be devised in the future.

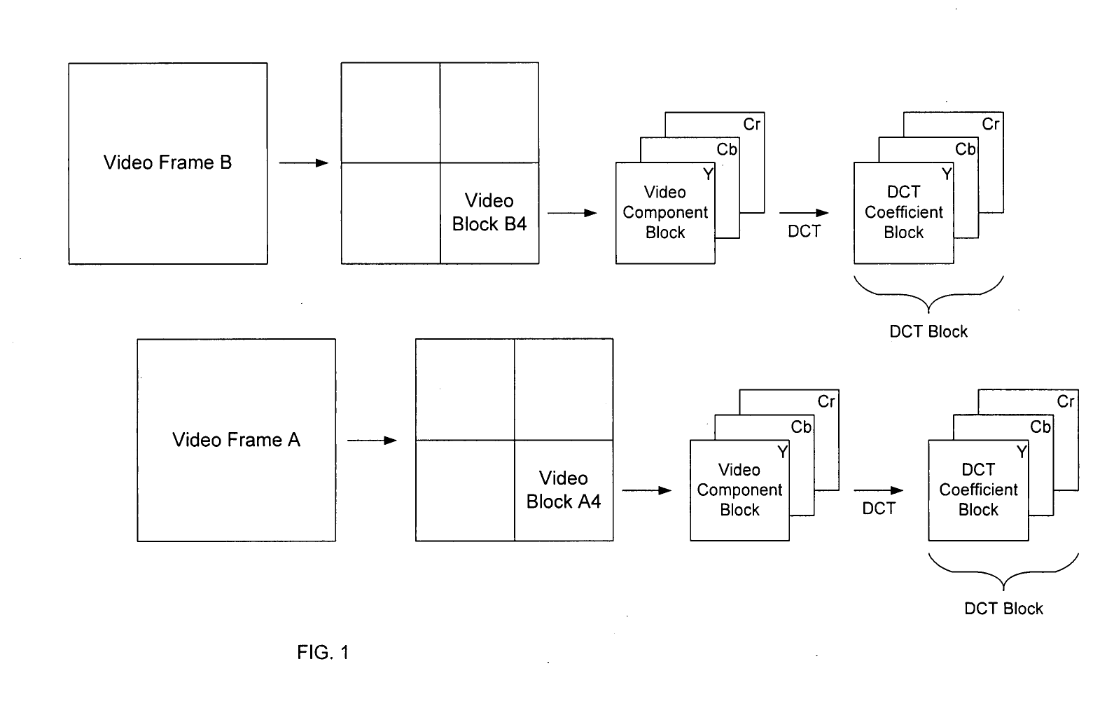

Turning now to FIG. 1, there are shown block level representations of a video frame and its constituent elements. In this exemplary video frame, the frame is constructed from 4 video blocks. Each block is constructed from 3 component blocks (each pixel is constructed from 3 components), in the example of FIG. 1 the components are Y, Cb, and Cr. Each of the component blocks of this example is transformed to a component DCT coefficient block by performing a discrete cosine transform on each of the blocks. Each pixel in the video frame may be represented by three colors Red, Green and Blue (R,G,B) or in some other encoding scheme such as YCbCr. Each color component or encoded component may be represented as a value with an accuracy of a certain number of bits (e.g. 11 bits for Y, 11 bits for Cb and 11 bits for Cr). Therefore, in order to store a full frame in memory, there may be a need for memory of the size of the number of pixels in the frame multiplied by the sum of the number of bits of each pixel's component. For example, a 1920×1080 pixels video frame with 11 bits for each of the R,G,B components will require 1920×1080×3×11=68,428,800 bits, or 8,553,600 bytes of memory for storing a single video frame. In order to determine whether the difference between the content of the video blocks in a video frame and the corresponding video blocks in a previous video frame is within a predetermined threshold, the previous frame may need to be stored in memory, and in the example above 8,553,600 bytes may be required for storage of the previous video frame.

According to some embodiments of the present invention, there are provided methods circuits and systems for comparing a video block in a video frame with a corresponding video blocks in a previous video frame and determining whether the difference between the compared video blocks is within a predetermined threshold. Optionally, the methods, circuit and systems may use less memory than needed for storing the entire video frame. According to some embodiments of the present invention, each video block may be assigned a video signature which may represent the content of the video block. According to some embodiments of the present invention, the signature of the video block may be stored in memory and compared to the signature of the corresponding video block of the next video frame to determine whether the difference between the content of the two frames is within a predetermined threshold. According to some embodiments of the present invention, the signatures of two video blocks may be compared to determine if the difference between the two video blocks is within a predetermined threshold.

According to some embodiments of the present invention, a video block signature may be generated by calculating a hash function of the pixels of the video block.

According to some embodiments of the present invention, the pixels of a video block of a video frame may be encoded in a YCbCr component encoding scheme. According to some other embodiments of the present invention, the pixels of a video block of a video frame may be encoded in a RGB component encoding scheme. According to some other embodiments of the present invention, the pixels of a video block of a video frame may be encoded in any other encoding scheme which is now known or which may be devised in the future.

According to some embodiments of the present invention, a video block signature may be generated for one or more blocks by calculating a hash function of the pixels of at least one of the video component blocks.

According to some embodiments of the present invention, a discrete cosine transform (DCT) may be applied to at least one component of the video block, generating one or more DCT coefficient blocks, one for each component. The DCT coefficients may be represented in the same accuracy of bits as the corresponding component or in a different number of bits accuracy. The discrete cosine transform (DCT) of each video block encoded component may have one DC coefficient and n̂2-1 AC coefficients, where n̂2 is the number of pixels in the video block. The n̂2 DCT coefficients may be referred to as the component DCT coefficient block. For example, in the YCbCr encoding scheme, there may be a Y DCT coefficient block, a Cb DCT coefficient block, and a Cr DCT coefficient block, all 3 component DCT coefficient blocks may be referred to as the DCT block.

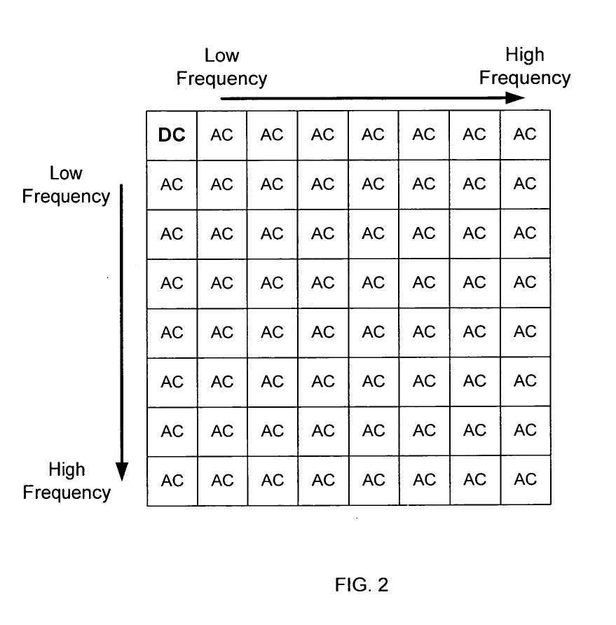

Turning now to FIG. 2, there is shown an example of an 8×8 discrete cosine transform of an 8×8 block. In the upper left corner there may be a DC coefficient that may be the average value of the 64 pixels of the block. Close to the DC coefficient there may be the low frequency coefficients, and further away the higher frequency coefficients.

According to some embodiments of the present invention, two or more video blocks may be grouped to form one bigger video block. According to some embodiments of the present invention, two or more DCT blocks may be grouped to form one bigger DCT block.

According to some embodiments of the present invention, a video block signature may be generated by calculating a hash function of the coefficients of at least one of the component DCT coefficient blocks. According to some embodiments of the present invention, a video block signature may be generated by calculating a hash function of the coefficients of the DCT block.

By calculating and comparing the hash function of two video blocks, or video component blocks, or DCT blocks, or component DCT coefficient blocks, blocks which are not completely identical in their video content may show a miss-match in their hash function. Since there may be some noise in the video signal (such as from the ND converter or from ambient light instability or for any other reason) and consecutive video frames may not be completely identical, there may be a need to let some threshold when comparing two video blocks.

According to some embodiments of the present invention, a video block signature may be generated by calculating a hash function of at least one of the coefficients of at least one of the component DCT coefficient blocks. According to some embodiments of the present invention, a video block signature may be generated by calculating a hash function of at least one of the coefficients of the DCT block. According to some embodiments of the present invention, a video block signature may be generated by calculating a hash function of at least the DC coefficient of at least one of the component DCT coefficient blocks. According to some embodiments of the present invention, a video block signature may be generated by calculating a hash function of at least the DC coefficient of the Y DCT coefficient block. According to some embodiments of the present invention, a video block signature may be generated by calculating a hash function of the DC coefficient and at least one AC coefficient, of at least one of the component DCT coefficient blocks. According to some embodiments of the present invention, a video block signature may be generated by calculating a hash function of the DC coefficient and at least one AC coefficient, of the Y DCT coefficient block. According to some embodiments of the present invention, a video block signature may be generated by calculating a hash function of at least the DC coefficients of each of the components of the DCT block. According to some embodiments of the present invention, a video block signature may be generated by calculating a hash function of the DC coefficients of each of the components, and at least one AC coefficient of each of the components, of the DCT block. According to some embodiments of the present invention, a video block signature may be the DC coefficient of at least one of the component DCT coefficient blocks. According to some embodiments of the present invention, a video block signature may be the DC coefficient of the Y DCT coefficient block. According to some embodiments of the present invention, a video block signature may be generated by the DC coefficient or a hash function of the DC coefficient, and calculating a hash function of at least one AC coefficient, of at least one of the component DCT coefficient blocks. According to some embodiments of the present invention, a video block signature may be generated by the DC coefficient or a hash function of the DC coefficient, and calculating a hash function of at least one AC coefficient, of the Y DCT coefficient block. According to some embodiments of the present invention, a video block signature may be the DC coefficients of each of the components of the DCT block. According to some embodiments of the present invention, a video block signature may be generated by the DC coefficient or a hash function of the DC coefficient of each of the components, and calculating a hash function of at least one AC coefficient of each of the components, of the DCT block. According to some embodiments of the present invention, a video block signature may be generated by calculating a hash function of at least one DC coefficient and at least one AC coefficient of the DCT block. According to some embodiments of the present invention, the at least one AC coefficients used for calculating the video block signature may be the lower frequency AC coefficients.

Most of an image's visible details are at or near DC—low frequency AC DCT coefficients. Therefore, according to some embodiments of the present invention the DC coefficients or near DC (low frequency AC) coefficients for the video block signature are used—thereby obviating mismatches which may occur due to high frequency noise.

There will now be described some systems, circuits and methods according to embodiments of the present invention which may introduce some tolerance to low frequency and/or DC noise:

According to some embodiments of the present invention, the bits of each DC coefficient may be divided into two parts, mx MS bits and nx LS bits in a way that mx+nx may equal the number of bits of the x DC coefficient. According to some embodiments of the present invention, the bits of each AC coefficient may be divided into two parts, my MS bits and ny LS bits in a way that my+ny may equal the number of bits of each y AC coefficient.

According to some embodiments of the present invention, the video block signature may include the n LS bits of at least one DC coefficient. According to some embodiments of the present invention, the video block signature may include the n LS bits of at least one AC coefficient.

According to some embodiments of the present invention, there may be a correction table for correcting a coefficient that differs from a corresponding previous coefficient within the threshold range to be equal to the previous coefficient, in a way that two blocks that differ from each other within the threshold range will have the same coefficients (after correction). According to some embodiments of the present invention, the correction table may be constructed from two or more LS bits of the previous coefficient, and the same number of bits of the current coefficient as an entry of the table, and an action as a result of the lookup in the table.

According to some embodiments of the present invention, the n LS bits of at least one DC and/or at least one AC coefficients of the current DCT block, and the corresponding n LS bits of at least one DC and/or at least one AC coefficients of the previous DCT block which may be stored in the previous block's signature stored in memory may be used as entries to the correction table. According to some embodiments of the present invention, the correction table may modify the m MS bits of at least one DC and/or at least one AC coefficients of the current DCT block, in a way that if the coefficients of the current and previous blocks differ from each other below a predefined threshold, the signature of the current block may be identical to the signature of the previous block.

For example, assuming a 4 bit coefficient and a threshold of 1. Two LS bits of the coefficient may be stored in memory as part of the coefficient signature.

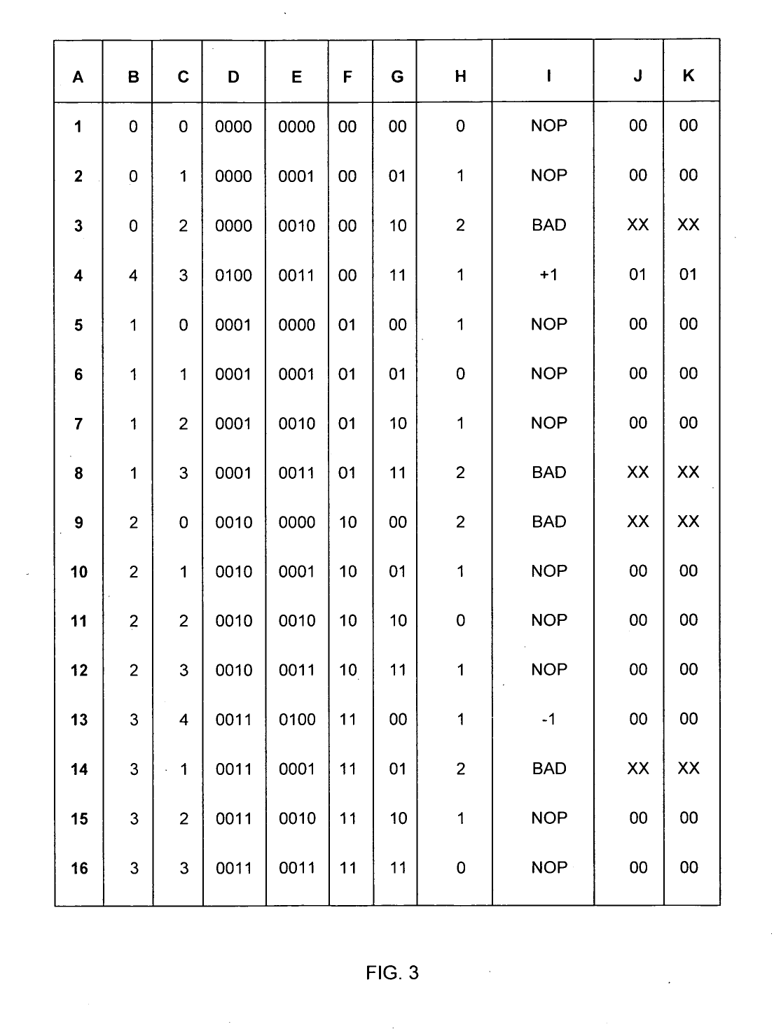

Turning now to FIG. 3, there are shown possible cases using two LS bits as part of the coefficient signature. Column B may be a coefficient of the previous block. Column C may be the corresponding coefficient of the current block. Column D is a binary representation of the coefficient in column B. Column E is a binary representation of the coefficient in column C. Column F in FIG. 3 may be the 2 LS bits of the coefficient of the previous block (the two LS bits of column D) which may be stored in memory as part of the signature of the previous block. Column G may be the 2 LS bits of the coefficient of the current block (the two LS bits of column E). Column H is the absolute value of the difference between the coefficient of the previous block and the coefficient of the current block. Column I is the action to be taken. Column J is the two MS bits of the coefficient in column D. Column K is the two MS bits of the coefficient in column E after the action in column I has been taken.

In lines 1, 6, 11 and 16 a coefficient of the previous block (column B) may be equal to the corresponding coefficient of the current block (column C), hence, the LS bits of the coefficient of the previous block (column F) may be equal to the corresponding LS bits of the coefficient of the current block (column G), and the MS bits of the coefficient of the previous block (column J) may be equal to the corresponding MS bits of the coefficient of the current block (column K), therefore no action should be taken (NOP) (column I).

In lines 2, 5, 7, 10, 12 and 15 a coefficient of the previous block (column B) may have a difference (column H) of 1 (within the threshold) compared to the corresponding coefficient of the current block (column C), the MS bits of the coefficient of the previous block (column J) may be equal to the corresponding MS bits of the coefficient of the current block (column K), therefore, when the LS bits of the coefficient of the previous block (column F) and the corresponding LS bits of the coefficient of the current block (column G) are as in lines 2, 5, 7, 10, 12, 15, no action should be taken (NOP) (column I).

In line 4 a coefficient of the previous block (column B) may be greater by 1 (column H) (within the threshold) than the corresponding coefficient of the current block (column C), the MS bits of the coefficient of the previous block (column D) may be ‘01 ’ while the corresponding MS bits of the coefficient of the current block (column E) may be ‘00 ’, therefore, when the LS bits of the coefficient of the previous block (column F) and the corresponding LS bits of the coefficient of the current block (column G) are ‘00’ and ‘11’ respectively, the MS bits of the coefficient of the current block (column E) may be incremented by 1 (action in column I) to get the MS bits of the coefficient of the current block (column K) equal to the MS bits of the corresponding coefficient of the previous block (column J).

In line 13 a coefficient of the previous block (column B) may be smaller by 1 (column H) (within the threshold) than the corresponding coefficient of the current block (column C), the MS bits of the coefficient of the previous block (column D) may be ‘00’ while the corresponding MS bits of the coefficient of the current block (column E) may be ‘01’, therefore, when the LS bits of the coefficient of the previous block (column F) and the corresponding LS bits of the coefficient of the current block (column G) are ‘11’ and ‘00’ respectively, the MS bits of the coefficient of the current block (column E) may be decremented by 1 (action in column I) to get the MS bits of the coefficient of the current block (column K) equal to the MS bits of the corresponding coefficient of the previous block (column J).

In lines 3, 8, 9 and 14 the difference between the coefficient of the previous block (column B) and the corresponding coefficient of the current block (column C) may be 2 (column H) which is greater than the threshold. In this case the content of the current block may not be similar (not within the threshold) to the content of the corresponding previous block. Therefore, when the LS bits of the coefficients of the previous block (column F) and the LS bits of the coefficients of the corresponding current block (column G) are [‘00’,‘10’]or [‘01’,‘11’] or [‘10,‘00’] or [‘11’,‘01’] an action (column I) may be taken determining that the content of the current block and the content of the corresponding previous block mismatch.

In the same way as described above, 3, 4 or more LS bits of the coefficients may be used for correcting the coefficients to match other thresholds.

After correcting the coefficients (the MS bits) of the current block according to the table just described, the corrected coefficients may be used for calculating the block's signature.

According to some embodiments of the present invention, a modified coefficient of the current block may be used for creating the signature of the block.

By storing a signature of the block and comparing it to the signature of the next block, less memory may be required. We will now show some examples, assuming a 8×8 pixel block with three colors and an accuracy of 11 bits per color per pixel. The total amount of memory required for storing the block is 8×8×3×11=2,112 bits.

Example 1, generating a signature by running the 2,112 bits through a hash function, in this way we may get a signature of any required length (e.g. 16 bits, 32 bits, 40 bits). In this way we may compare the signatures of two blocks to determine if they may be identical or not but we cannot determine any threshold for tolerance between the content of the two blocks.

Example 2, generating a signature that may include the two LS bits of all 64×3 pixels and a hash, the total number of bits needed may be 8×8×3×2+ hash. Assuming a 32 bit hash the total number of bits for the signature may be 416. The two LS bits of each bit may be used for correcting the color in order to enable a tolerance threshold of 1.

A 32 bit hash will be assumed for all further examples.

Example 3, since the color blocks of an image may be related, one color may be used for generating a signature, in this case the signature size may be 8×8×2+32=160 bits, and there may be tolerance threshold of 1.

Example 4, the image block may be encoded in YCrCb encoding format. A discrete cosine transform (DCT) may be applied to each of the Y, Cb and Cr blocks to generate a Y DCT coefficient block, a Cb DCT coefficient block and a Cr DCT coefficient block. The signature may be constructed from 2 bits of 20 coefficients from each DCT coefficient block and a hash. The total signature size may be 3×20×2+32=152 bits and there may be tolerance threshold of 1.

Example 5, the image block may be represented as a DCT YCrCb encoded blocks as in the previous example. The signature may be constructed from 2 bits of 8 coefficients from each DCT coefficient block and a hash. The total signature size may be 3×8×2+32=80 bits and there may be tolerance threshold of 1.

Example 6, since most of the image AC information resides in the Luma (Y) coefficient block, the signature may be constructed from the DC coefficient of each DCT coefficient block and 2 bits of 8 coefficients from the Y DCT coefficient block. The total signature size may be 3×11+8×2+32=81 bits, and there may be tolerance threshold of 1.

Example 7, In order to further decrease the signature size but still not compromise on accuracy, the DC components of the chroma coefficients may be hashed separately from the AC coefficients. For example, the DC coefficient of the Y block may be hashed to 9 bits, and the DC coefficients of the Cb and Cr blocks may be hashed to 6 bits since they may include less critical information than the Y component. The signature may then include 9+6+6+8×2+32=69 bits, and there may be tolerance threshold of 1.

Example 8, in this example a 16 bit hash function may be used for 8 AC coefficients of the Y DCT coefficient block, 3 LS bits from each of the 8 AC coefficients may be used for a tolerance threshold of 3, a 9 bit hash function may be used for the Y DC coefficient, and a 5 bit hash function may be used for each of the Cb and Cr coefficients. The total signature size may then be 9+5+5+8×3+16=59 bits, and there may be tolerance threshold of 3.

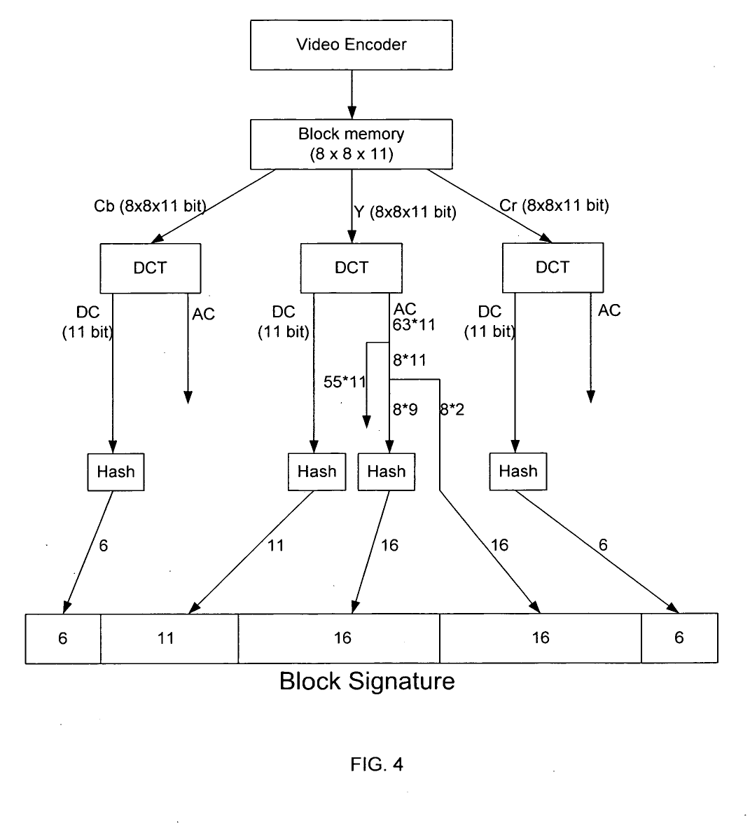

FIG. 4 shows an example of a block of 8×8 pixels×11 bit. The block is YCbCr encoded and stored in memory. A DCT is performed on each of the components to create one 11 bit DC coefficient and 63 AC coefficients for each of the components. In the example of this figure, the signature may be constructed from a 6 bit hash of the DC coefficient of the Cb component, the 11 bit DC coefficient and a 16 bit hash of 8 AC coefficients of the Y component, the 2 LS bits of the 8 AC coefficients of the Y component, and a 6 bit hash of the DC coefficient of the Cr component. In total the signature in the example of this figure is 6+11+16+16+6=55 bits.

According to some embodiments of the present invention, a current video block may be defined as static if the signature of the current block matches the signature of the previous block. According to some embodiments of the present invention, a current video block may be defined as static if the signature of the current block matches the signature of previous corresponding blocks for a predefined number of consecutive times. According to some embodiments of the present invention, a counter may be added to the video block signature logic for counting the number of times the video block matches the previous video block. According to some embodiments of the present invention, each time the signature of the video block matches the signature of the previous video block, the counter may be incremented. According to some embodiments of the present invention, upon the counter reaching a predefined number, the frame may be declared/defined as static and the counter may be decremented or reset. According to some embodiments of the present invention, each time the signature of the video block does not match the signature of the previous video block, the counter may be cleared (zeroed).

According to some embodiments of the present invention, the signature of a static block stored in memory may be replaced with a new signature which may be a function of the stored signature and the signature of a new static block.

For example, the function may operate on each stored coefficient or each stored LS bits of the coefficients. Some example functions may be:

IF(count<8)then sig=(new*(8-count)+old*count)/8;

IF(count<8)then sig=(new+old*(2̂count−1)/(2̂count);

where:

“count” may be the counter counting consecutive static blocks.

“new” may be a coefficient or the LS bits of a coefficient, which is part of the signature of a new static block.

“old” may be a coefficient or the LS bits of a coefficient, which is part of the signature stored in memory.

“sig” may be a coefficient or the LS bits of a coefficient, which may replace the “old” in memory.

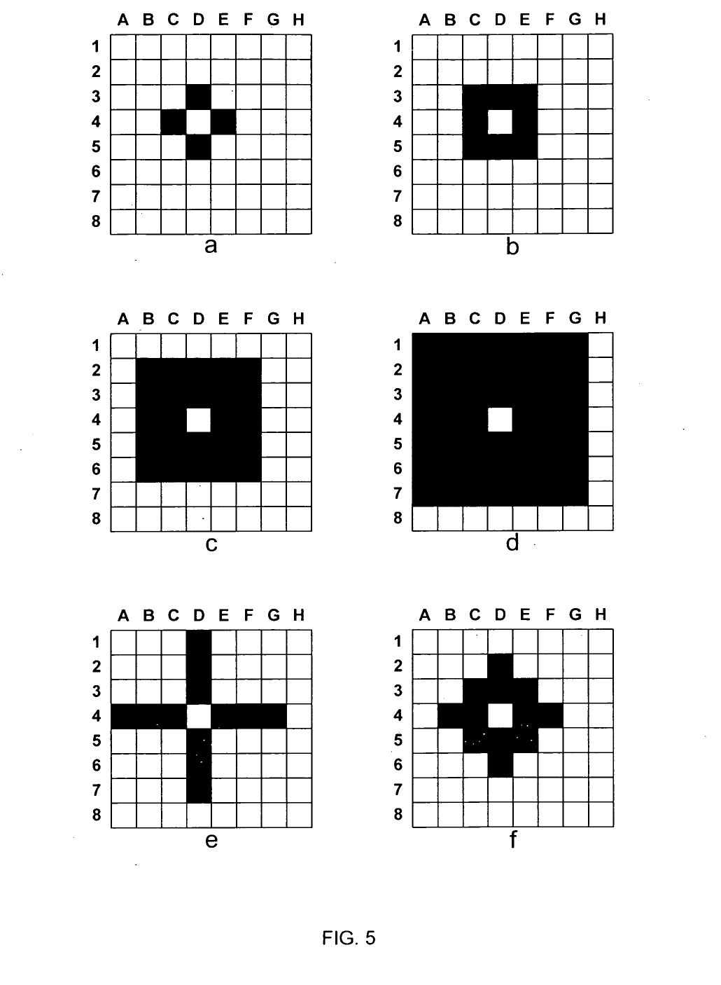

According to some embodiments of the present invention, a video block may be defined static only if its N neighbors in the horizontal direction (the neighbors to its right and left) and its M neighbors in the vertical direction (the neighbors above and below) are static. FIG. 5a shows an example of the neighbors of block B4 where N=1 and M=1. FIG. 5e shows an example of the neighbors of block B4 where N=3 and M=3.

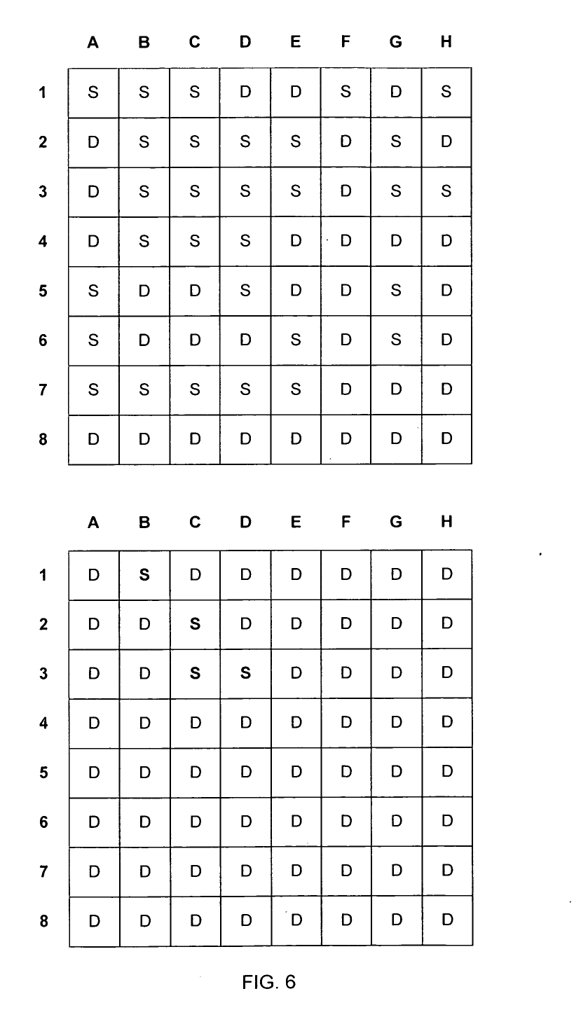

Turning now to FIG. 6, there is shown an example of dynamic and static video blocks in a video frame. The frame in this example is constructed from 8×8 video blocks. The top video frame describes the blocks that were considered static or dynamic based on comparing the current video blocks to the previous corresponding video blocks. S—stands for static, and D—stands for dynamic. The bottom video frame describes the static blocks that have static neighbors. Block C3 is static since it was static in the top video frame and has static vertical C2 and C4 neighbors and static horizontal B3 and D3 neighbors. Block C4 is static in the top frame, but dynamic in the bottom frame since its C5 neighbor is dynamic while all other neighbors are static.

According to some embodiments of the present invention, a video block may be defined static only if its 8 surrounding neighbors are static. For example, the surrounding neighbors of block C3 in FIG. 6 are B2, C2, D2, D3, D4, C4, B4, B3.

FIG. 5b shows an example of the 8 surrounding neighbors of block B4.

According to some embodiments of the present invention, a video block may be defined static only if the block's predefined neighbors are static. FIGS. 5c, 5d and 5f show some examples of predefined neighbors of block D4.

According to some embodiments of the present invention, a video block may be defined static only if a certain percent of the block's predefined neighbors are static.

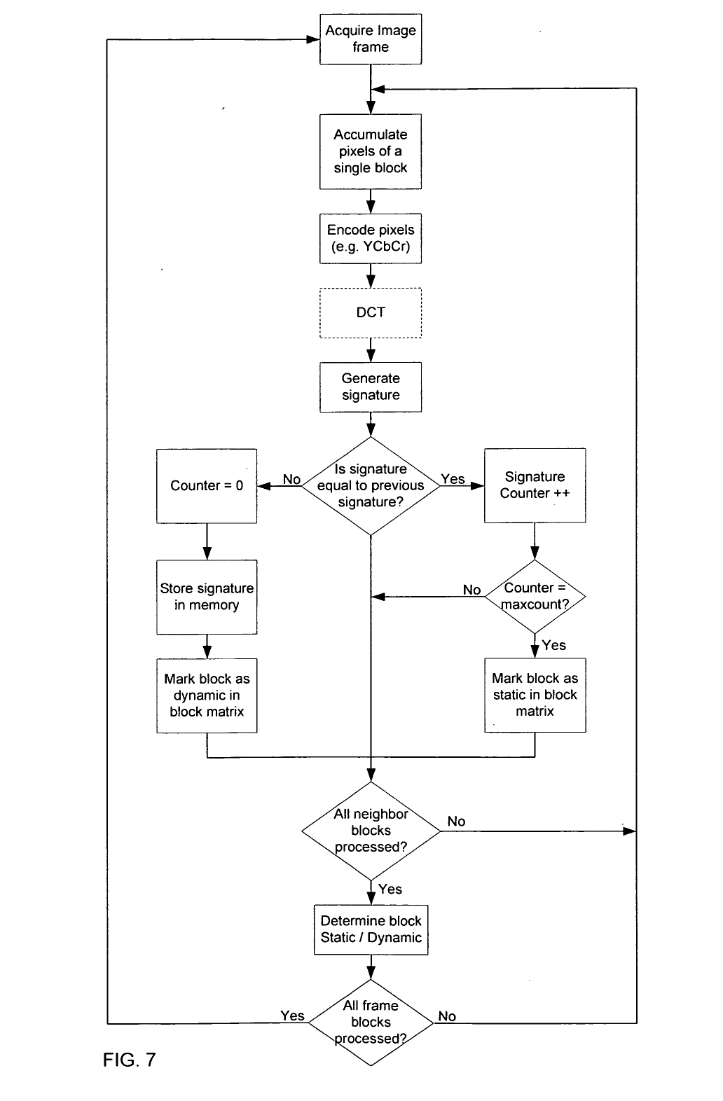

Turning now to FIG. 7, there is shown an exemplary flowchart including the steps of some exemplary methods according to some embodiments of the present invention. According to this example, an image frame may be acquired and the frame pixels may be grouped to blocks. The pixels may be encoded (e.g YCrCb encoding) and a block signature may be generated. The block signature generation may require calculating a discrete cosine transform (DCT) of the block. The calculated signature may be compared to the signature stored in memory of a corresponding block in the previous frame. If the two signatures are equal, a signature counter may be incremented and checked whether it reached a predefined count, if the counter reached its terminal count the block is marked as static in a block matrix. If the calculated signature is not equal to the corresponding previous signature stored in memory, the signature's counter may be reset and the calculated signature may be stored in memory in place of the corresponding previous signature, and the block may be marked as dynamic in the block matrix. The matrix may be scanned to determine if a block is static or dynamic according to its neighbors being static/dynamic.

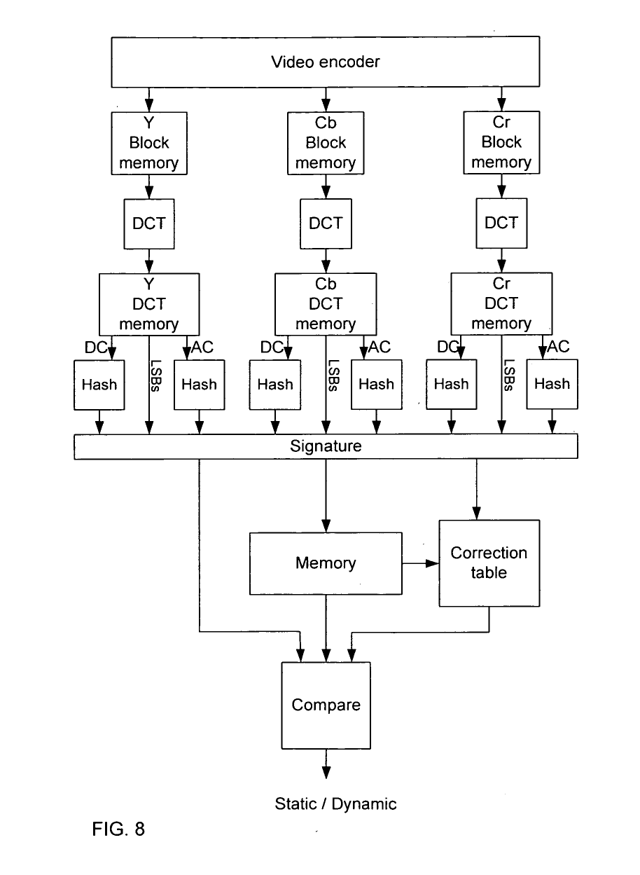

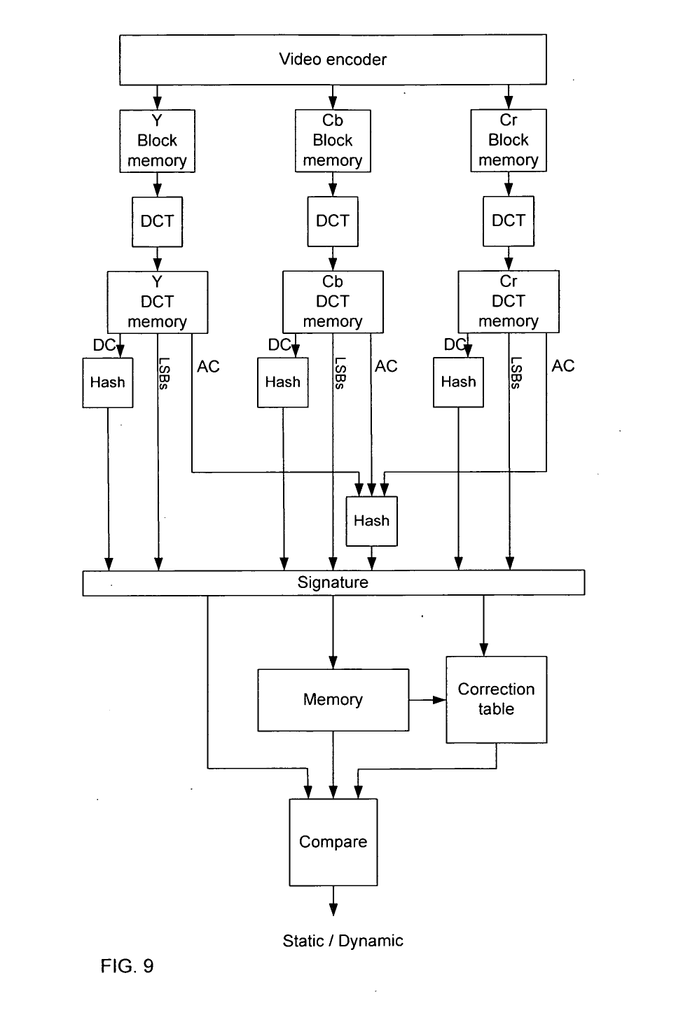

Turning now to FIGS. 8 and 9, there are shown exemplary block diagrams of a digital processing and/or logic circuits according to some embodiments of the present invention. A video frame may be encoded by the video encoder into a luma (Y) block and two chroma blocks Cb and Cr. A discrete cosine transform (DCT) may be performed on the three blocks to create a Y, Cb and Cr DCT coefficient blocks. The DC coefficient of each block may pass through a hash function, and the results of the hash functions may be part of the signature. One or more AC coefficients from each block may go through a separate hash function as in FIG. 8, or through one hash function as in FIG. 9, the hash function result(s) may be part of the signature. Two or more LS bits of each of the coefficients that were hashed may also be part of the signature. The signature may be a concatenation of all of the bits. In order to determine whether a block is static or dynamic, a comparator may compare parts of the signature of the previous block which may be stored in memory with parts of the signature of the current block, and parts of the signature of the previous block which may be stored in memory with parts of the signature of the current block which may be corrected by the correction table. The calculated signature of the current block may be stored in memory (replacing the signature of the previous block) for comparison with the next block.

It should be understood that each functional component/block shown as discrete in any of the above listed figures may be a process running on a processor (general purpose or dedicated) or may be a processing/logic circuit which is either discrete or part of a larger integrated circuit.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A method for processing video data comprising:
determining a deviation between a given video block in a current video frame relative to a corresponding video block in a previous video frame by comparing a signature of the given block with a signature of the corresponding previous video block.

2. The method according to claim 1, further comprising generating a signature for the given video block by performing a discrete cosine transform (DCT) on one or more of component blocks of the given video block to produce one or more DCT blocks of coefficients.

3. The method according to claim 2, wherein a video block signature is generated by calculating a hash function of at least one of the coefficients of at least one of the DCT blocks.

4. The method according to claim 2, wherein a video block signature is generated by calculating a hash function of at least a DC coefficient of at least one of the component DCT coefficient block.

5. The method according to claim 2, wherein a video block signature is generated by calculating a hash function of at least a DC coefficient of a Y DCT coefficient block.

6. The method according to claim 2, wherein a video block signature is generated by calculating a hash function of a DC coefficient and at least one AC coefficient, of at least one of the component DCT coefficient blocks.

7. The method according to claim 2, wherein a video block signature may be generated by calculating a hash function of a DC coefficient and at least one AC coefficient of a Y DCT coefficient block.

8. The method according to claim 1, further comprising designating the current video block a static when the determined deviation is below a threshold value.

9. A video transmitting device comprising:
a video block signature generator adapted to generate a signature for a given block in a current video frame; and
a comparator adapted to determine a deviation between the given video block of the current video frame relative to a corresponding video block in a previous video frame by comparing signatures of the two video blocks.

10. The device according to claim 9, wherein said generator is adapted to generate a signature for the given video block by performing a discrete cosine transform (DCT) on one or more of component blocks of the given video block to produce one or more DCT blocks of coefficients.

11. The device according to claim 10, wherein a video block signature is generated by calculating a hash function of at least one of the coefficients of at least one of the DCT blocks.

12. The device according to claim 10, wherein a video block signature is generated by calculating a hash function of at least a DC coefficient of at least one of the component DCT coefficient block.

13. The device according to claim 10, wherein a video block signature is generated by calculating a hash function of at least a DC coefficient of a Y DCT coefficient block.

14. The device according to claim 10, wherein a video block signature is generated by calculating a hash function of a DC coefficient and at least one AC coefficient, of at least one of the component DCT coefficient blocks.

15. The device according to claim 10, wherein a video block signature may be generated by calculating a hash function of a DC coefficient and at least one AC coefficient of a Y DCT coefficient block.
